(19) United States
(12) Patent Application Publication
(10) Pub. No.: US 2017/0252759 A1
(43) Pub. Date: Sep. 7, 2017

(54) EXTRUSION FOAM PUMP AND METHOD FOR GENERATING FOAMS BY FOAM PUMP

(71) Applicant: Yuanhong MEI, Guangdong (CN)

(72) Inventor: Yuanhong MEI, GUANGDONG (CN)

(21) Appl. No.: 15/038,473

(22) PCT Filed: Dec. 16, 2014
(86) PCT No.: PCT/CN2014/001128

§ 371 Date: May 23, 2016

(30) Foreign Application Priority Data
Oct. 24, 2014 (CN) 201410574155.6

(51) Int. Cl. B05B 7/00; B05B 12/00; A47K 5/14

(52) U.S. Cl. CPC B05B 7/005; A47K 5/14; B05B 12/002

(57) ABSTRACT

The present invention relates to an extrusion foam pump and a method for generating foams by the foam pump. The extrusion foam pump includes an extrusion bottle and a foam pump body, the foam pump body is inserted in the extrusion bottle, liquid is filled in the extrusion bottle, when in use, people applies an external acting force to the extrusion bottle, and meanwhile by means of the action of the foam pump body, the extrusion foam pump can generate air-liquid mixed foams to be used by people, the foam pump body includes a thread cap, a valve fixing seat, a splitter and a blade valve, a lower end of an air-water replacement pipe is inserted in the extrusion bottle, and the top of the air-water replacement pipe is connected with the splitter.

### FIELD OF THE INVENTION

The present invention relates to an extrusion foam pump and a method for generating foams by the foam pump, and in particular, to a foam pump capable of obtaining air-liquid mixed foams in an extrusion manner and a method for generating foams.

### BACKGROUND OF THE INVENTION

As we all know, with the progress of the society, more and more articles capable of providing convenience for the daily lives of people have been widely used in the lives of people, now people pay more attention to their own health and hygiene issues, in order to maintain the cleanness of human body, people are accustomed to using some cleaning liquid to wash hands, wash the face or have a bath, in order to meet the demands of people, a large amount of facial wash, liquid soap, shower gel and other cleaning liquid have appeared on the market, for the convenience of placement and use, such liquid is generally placed in containers like bottles, and people can quantitatively pour out such liquid when in specific use to achieve a cleaning use purpose. When using such liquid in early stages, people need to manually incline containers holding such liquid at a certain angle, so that the liquid can automatically flow out to be used, however, this usage mode is very inconvenient, and excessive liquid is generally poured out to generate waste, to overcome such a shortcoming, a pressing pump body is generally installed at the top of the container for holding such liquid, and in specific use, people can press the pump body at the top to quantitatively extrude out the liquid, thereby facilitating people using it.

This kind of pressing pump body on the current market generally has the shortcomings of unreasonable extrusion mode, poor foaming effect, complex structure and instable function, and this is the main drawback of the traditional technology. In addition, this kind of pressing pump body is also widely applied to hair dyes, kitchen cleaning agents and other fields, and also has the above shortcomings in specific use.

### SUMMARY OF THE INVENTION

The present invention provides an extrusion foam pump and a method for generating foams by the foam pump. The generated foams are sufficient, fine and smooth, the amount of the generated foams can be randomly controlled by the deformation amount of extruding a bottle or extruding an airbag-shaped object, moreover, the overall structure is simple, the function is stable, the use of people are convenient, and this is the main object of the present invention.

The technical solution adopted by the present invention is as follows: an extrusion foam pump includes an extrusion bottle and a foam pump body, the foam pump body is inserted in the extrusion bottle, liquid is filled in the extrusion bottle, when in use, people applies an external acting force to the extrusion bottle, and meanwhile by means of the action of the foam pump body, the extrusion foam pump can generate air-liquid mixed foams to be used by people.

The foam pump body includes a thread cap, a valve fixing seat, a splitter and a blade valve, wherein the thread cap covers the extrusion bottle to connect the foam pump body to the extrusion bottle, an air-liquid foam outlet is formed in the top of the thread cap, the valve fixing seat is inserted in the thread cap, an air-liquid passage is arranged at the center of the valve fixing seat, the air-liquid passage is communicated with the air-liquid foam outlet, a filter screen is arranged at the top of the air-liquid passage and between the thread cap and the valve fixing seat, a second mixing area is formed in the inner cavity of the filter screen, and a first mixing area is formed between the bottom of the filter screen and the valve fixing seat.

A lower end of an air-water replacement pipe is inserted in the extrusion bottle, the top of the air-water replacement pipe is connected with the splitter, the splitter is inserted in the valve fixing seat, the blade valve is clamped between the splitter and the valve fixing seat, the blade valve includes an inner blade and an outer blade, an air return hole is formed in the surrounding of the valve fixing seat, and the outer blade movably covers the air return hole from below.

The splitter is provided with a liquid inlet hole, an air inlet hole and a splitter air return hole, the inner blade movably covers the tops of the liquid inlet hole and the air inlet hole, the liquid inlet hole and the air inlet hole are formed in the top of the splitter relative to the valve fixing seat, and the splitter air return hole is formed in the surrounding of the splitter.

A method for generating foams by an extrusion foam pump includes the following steps:

a first step, a gland is taken off from the extrusion foam pump, wherein the extrusion foam pump includes an extrusion bottle and a foam pump body, the foam pump body is inserted in the extrusion bottle, liquid is filled in the extrusion bottle, the foam pump body includes a thread cap, a valve fixing seat, a splitter and a blade valve, wherein the thread cap covers the extrusion bottle to connect the foam pump body to the extrusion bottle, an air-liquid foam outlet is formed in the top of the thread cap, the valve fixing seat is inserted in the thread cap, an air-liquid passage is arranged at the center of the valve fixing seat, the air-liquid passage is communicated with the air-liquid foam outlet, a filter screen is arranged at the top of the air-liquid passage and between the thread cap and the valve fixing seat, a second mixing area is formed in the inner cavity of the filter screen, and a first mixing area is formed between the bottom of the filter screen and the valve fixing seat.

A lower end of an air-water replacement pipe is inserted in the extrusion bottle, the top of the air-water replacement pipe is connected with the splitter, the splitter is inserted in the valve fixing seat, the blade valve is clamped between the splitter and the valve fixing seat, the blade valve includes an inner blade and an outer blade, an air return hole is formed in the surrounding of the valve fixing seat, the outer blade movably covers the air return hole from below, the splitter is provided with a liquid inlet hole, an air inlet hole and a splitter air return hole, the inner blade movably covers the tops of the liquid inlet hole and the air inlet hole, the liquid inlet hole and the air inlet hole are formed in the top of the splitter relative to the valve fixing seat, and the splitter air return hole is formed in the surrounding of the splitter.

A second step, an external acting force is applied to the extrusion bottle to extrude the extrusion bottle, at this time, the liquid in the extrusion bottle rises along the air-water replacement pipe after being applied with the extrusion acting force, enters the liquid inlet hole and meanwhile proceeds into the first mixing area after pushing away the inner blade of the blade valve, at the same time, the air between the valve fixing seat and the splitter proceeds into the air inlet hole after being applied with the extrusion acting force, and meanwhile proceeds into the first mixing area after pushing away the inner blade of the blade valve, the liquid and the air are preliminarily mixed in the first mixing area to form an air-liquid mixture, the air-liquid mixture continues to rise to enter the second mixing area and form a foam air-liquid mixture when passing through the filter screen, and the foam air-liquid mixture is jet out from the air-liquid foam outlet finally.

A third step, the external acting force acting on the extrusion bottle is removed, the inner blade is pressed on and covers the liquid inlet hole and the air inlet hole simultaneously by means of an inner suction force generated by the recovery deformation force of the extrusion bottle, so as to seal the liquid inlet hole and the air inlet hole, at the same time, the outer blade is opened from the air return hole, the air at the outside of the valve fixing seat enters the space between the valve fixing seat and the splitter through the air return hole and further enters the extrusion bottle through the splitter air return hole and the air-water replacement pipe, in order to recover the extrusion bottle to the original state, and the cyclic process is repeated in this way.

The present invention has the beneficial effects that the foams generated by using the foam pump of the present invention are sufficient, fine and smooth, the amount of the generated foams can be randomly controlled by the deformation amount of extruding a bottle or extruding an airbag-shaped object, moreover, the overall structure is simple, the function is stable, and the use of people are convenient.

### BRIEF DESCRIPTION OF THE DRAWINGS

FIG. 1 is a schematic diagram of a structure of the present invention.

FIG. 2 is a schematic diagram of liquid intake of the present invention.

FIG. 3 is a schematic diagram of air intake of the present invention.

### DETAILED DESCRIPTION OF THE EMBODIMENTS

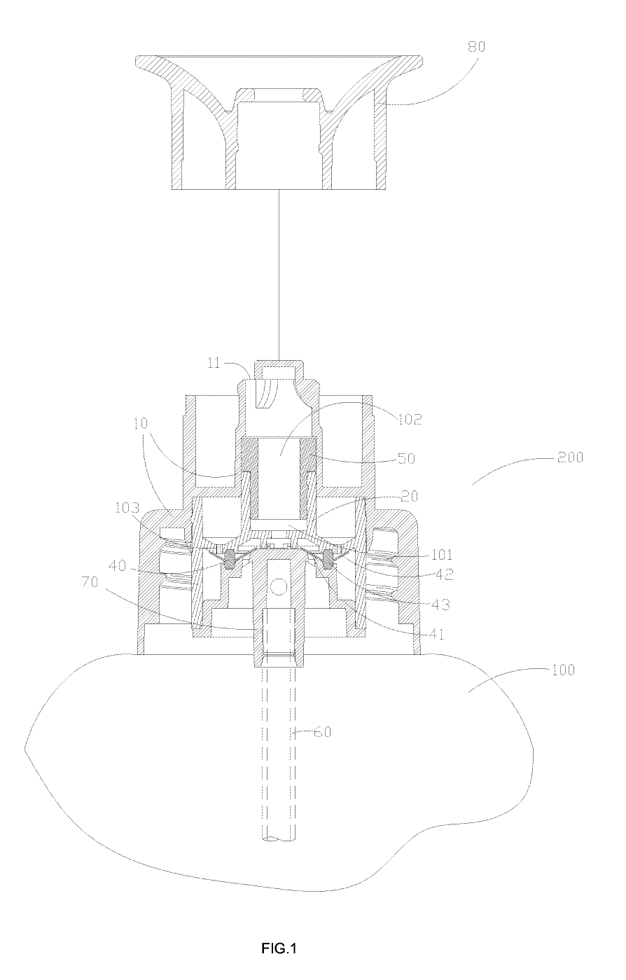

As shown in FIGS. 1 to 3, an extrusion foam pump includes an extrusion bottle 100 and a foam pump body 200, the foam pump body 200 is inserted in the extrusion bottle 100, liquid is filled in the extrusion bottle 100, for example, liquid soap, shower gel and the like, when in use, people applies an external acting force to the extrusion bottle 100, and meanwhile by means of the action of the foam pump body 200, the extrusion foam pump can generate air-liquid mixed foams to be used by people.

The foam pump body 200 includes a thread cap 10, a valve fixing seat 20, a splitter 70 and a blade valve 40, wherein the thread cap 10 covers the extrusion bottle 100 to connect the foam pump body 200 to the extrusion bottle 100.

An air-liquid foam outlet 11 is formed in the top of the thread cap 10, the valve fixing seat 20 is inserted in the thread cap 10, an air-liquid passage is arranged at the center of the valve fixing seat 20, and the air-liquid passage is communicated with the air-liquid foam outlet 11.

A filter screen 50 is arranged at the top of the air-liquid passage and between the thread cap 10 and the valve fixing seat 20, a second mixing area 102 is formed in the inner cavity of the filter screen 50, and a first mixing area 101 is formed between the bottom of the filter screen 50 and the valve fixing seat 20.

A lower end of an air-water replacement pipe 60 is inserted in the extrusion bottle 100, the top of the air-water replacement pipe 60 is connected with the splitter 70, and the splitter 70 is inserted in the valve fixing seat 20.

The blade valve 40 is clamped between the splitter 70 and the valve fixing seat 20, the blade valve 40 includes an inner blade 41 and an outer blade 42, in specific implementation, the blade valve 40 further includes a connecting rib 43, the inner blade 41 and the outer blade 42 are respectively arranged on inner and outer sides of the connecting rib 43, an air return hole 103 is formed in the surrounding of the valve fixing seat 20, and the outer blade 42 movably covers the air return hole 103 from below.

The splitter 70 is provided with a liquid inlet hole 104, an air inlet hole 105 and a splitter air return hole 106, the inner blade 41 movably covers the tops of the liquid inlet hole 104 and the air inlet hole 105, the liquid inlet hole 104 and the air inlet hole 105 are formed in the top of the splitter 70 relative to the valve fixing seat 20, the splitter air return hole 106 is formed in the surrounding of the splitter 70, and in specific implementation, the air inlet hole 105 is communicated with the splitter air return hole 106.

In specific implementation, the extrusion foam pump further includes a gland 80, and when the extrusion foam pump is in a non-working state, the gland 80 covers the top of the thread cap 10 and is pressed on the air-liquid foam outlet 11 for sealing effect.

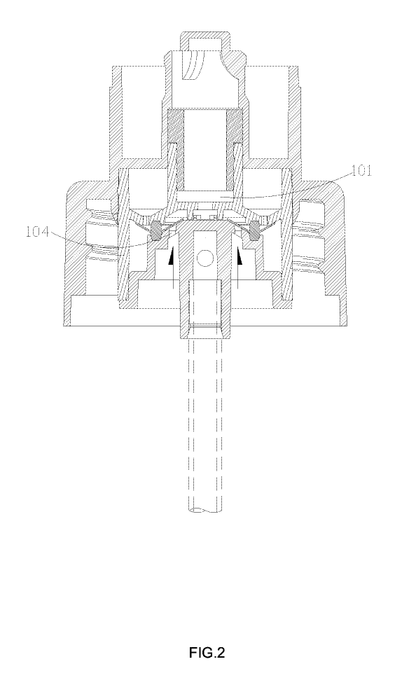

When the extrusion foam pump works, people applies an external acting force to the extrusion bottle 100 to extrude the extrusion bottle 100, at this time, the liquid in the extrusion bottle 100 rises along the air-water replacement pipe 60 after being applied with the extrusion acting force, enters the liquid inlet hole 104 and meanwhile proceeds into the first mixing area 101 (as shown by an arrow in FIG. 2) after pushing away the inner blade 41 of the blade valve 40.

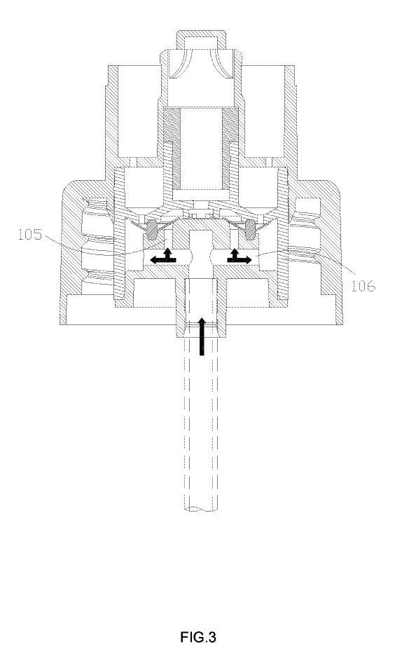

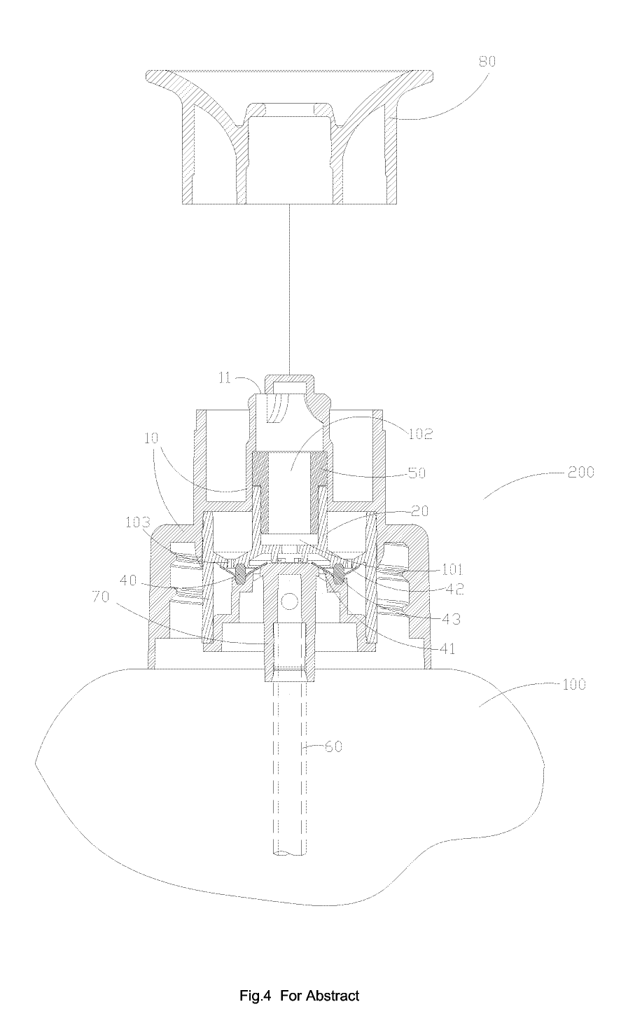

At the same time, the air between the valve fixing seat 20 and the splitter 30 proceeds into the air inlet hole 105 after being applied with the extrusion acting force, and meanwhile proceeds into the first mixing area 101 (as shown by an arrow in FIG. 3) after pushing away the inner blade 41 of the blade valve 40.

The liquid and the air are preliminarily mixed in the first mixing area 101 to form an air-liquid mixture, the air-liquid mixture continues to rise to enter the second mixing area 102 and form a foam air-liquid mixture when passing through the filter screen 50, and the foam air-liquid mixture is jet out from the air-liquid foam outlet 11 finally to be used by people.

After the external acting force acting on the extrusion bottle 100 is removed, the inner blade 41 is pressed on and covers the liquid inlet hole 104 and the air inlet hole 105 simultaneously by means of an inner suction force generated by the recovery deformation force of the extrusion bottle 100, so as to seal the liquid inlet hole 104 and the air inlet hole 105.

At the same time, the outer blade 42 is opened from the air return hole 103, the air at the outside of the valve fixing seat 20 enters the space between the valve fixing seat 20 and the splitter 30 through the air return hole 103 and further enters the extrusion bottle 100 through the splitter air return hole 106 and the air-water replacement pipe 60, in order to recover the extrusion bottle 100 to the original state, and the cyclic process is repeated in this way.

A method for generating foams by an extrusion foam pump includes the following steps:

a first step, a gland 80 is taken off from the extrusion foam pump, wherein the extrusion foam pump includes an extrusion bottle 100 and a foam pump body 200, the foam pump body 200 is inserted in the extrusion bottle 100, and liquid is filled in the extrusion bottle 100.

The foam pump body 200 includes a thread cap 10, a valve fixing seat 20, a splitter 30 and a blade valve 40, wherein the thread cap 10 covers the extrusion bottle 100 to connect the foam pump body 200 to the extrusion bottle 100, an air-liquid foam outlet 11 is formed in the top of the thread cap 10, the valve fixing seat 20 is inserted in the thread cap 10, an air-liquid passage is arranged at the center of the valve fixing seat 20, the air-liquid passage is communicated with the air-liquid foam outlet 11, a filter screen 50 is arranged at the top of the air-liquid passage and between the thread cap 10 and the valve fixing seat 20, a second mixing area 102 is formed in the inner cavity of the filter screen 50, and a first mixing area 101 is formed between the bottom of the filter screen 50 and the valve fixing seat 20.

A lower end of an air-water replacement pipe 60 is inserted in the extrusion bottle 100, the top of the air-water replacement pipe 60 is connected with the splitter 70, the splitter 70 is inserted in the valve fixing seat 20, the blade valve 40 is clamped between the splitter 70 and the valve fixing seat 20, the blade valve 40 includes an inner blade 41 and an outer blade 42, an air return hole 103 is formed in the surrounding of the valve fixing seat 20, and the outer blade 42 movably covers the air return hole 103 from below.

The splitter 70 is provided with a liquid inlet hole 104, an air inlet hole 105 and a splitter air return hole 106, the inner blade 41 movably covers the tops of the liquid inlet hole 104 and the air inlet hole 105, the liquid inlet hole 104 and the air inlet hole 105 are formed in the top of the splitter 70 relative to the valve fixing seat 20, and the splitter air return hole 106 is formed in the surrounding of the splitter 70.

A second step, an external acting force is applied to the extrusion bottle 100 to extrude the extrusion bottle 100, at this time, the liquid in the extrusion bottle 100 rises along the air-water replacement pipe 60 after being applied with the extrusion acting force, enters the liquid inlet hole 104 and meanwhile proceeds into the first mixing area 101 after pushing away the inner blade 41 of the blade valve 40.

At the same time, the air between the valve fixing seat 20 and the splitter 30 proceeds into the air inlet hole 105 after being applied with the extrusion acting force, and meanwhile proceeds into the first mixing area 101 after pushing away the inner blade 41 of the blade valve 40.

The liquid and the air are preliminarily mixed in the first mixing area 101 to form an air-liquid mixture, the air-liquid mixture continues to rise to enter the second mixing area 102 and form a foam air-liquid mixture when passing through the filter screen 50, and the foam air-liquid mixture is jet out from the air-liquid foam outlet 11 finally.

A third step, the external acting force acting on the extrusion bottle 100 is removed, the inner blade 41 is pressed on and covers the liquid inlet hole 104 and the air inlet hole 105 simultaneously by means of an inner suction force generated by the recovery deformation force of the extrusion bottle 100, so as to seal the liquid inlet hole 104 and the air inlet hole 105.

At the same time, the outer blade 42 is opened from the air return hole 103, the air at the outside of the valve fixing seat 20 enters the space between the valve fixing seat 20 and the splitter 30 through the air return hole 103 and further enters the extrusion bottle 100 through the splitter air return hole 106 and the air-water replacement pipe 60, in order to recover the extrusion bottle 100 to the original state, and the cyclic process is repeated in this way.

1. An extrusion foam pump, comprising an extrusion bottle and a foam pump body, wherein the foam pump body is inserted in the extrusion bottle, liquid is filled in the extrusion bottle, when in use, people applies an external acting force to the extrusion bottle, and meanwhile by means of the action of the foam pump body, the extrusion foam pump can generate air-liquid mixed foams to be used by people,
the foam pump body comprises a thread cap, a valve fixing seat, a splitter and a blade valve, wherein the thread cap covers the extrusion bottle to connect the foam pump body to the extrusion bottle, an air-liquid foam outlet is formed in the top of the thread cap, the valve fixing seat is inserted in the thread cap, an air-liquid passage is arranged at the center of the valve fixing seat, the air-liquid passage is communicated with the air-liquid foam outlet, a filter screen is arranged at the top of the air-liquid passage and between the thread cap and the valve fixing seat, a second mixing area is formed in the inner cavity of the filter screen, and a first mixing area is formed between the bottom of the filter screen and the valve fixing seat,
a lower end of an air-water replacement pipe is inserted in the extrusion bottle, the top of the air-water replacement pipe is connected with the splitter, the splitter is inserted in the valve fixing seat, the blade valve is clamped between the splitter and the valve fixing seat, the blade valve comprises an inner blade and an outer blade, an air return hole is formed in the surrounding of the valve fixing seat, and the outer blade movably covers the air return hole from below, and
the splitter is provided with a liquid inlet hole, an air inlet hole and a splitter air return hole, the inner blade movably covers the tops of the liquid inlet hole and the air inlet hole, the liquid inlet hole and the air inlet hole are formed in the top of the splitter relative to the valve fixing seat, and the splitter air return hole is formed in the surrounding of the splitter.

2. The extrusion foam pump of claim 1, wherein the blade valve further comprises a connecting rib, and the inner blade and the outer blade are respectively arranged on inner and outer sides of the connecting rib.

3. The extrusion foam pump of claim 1, wherein the air inlet hole is communicated with the splitter air return hole.

4. The extrusion foam pump of claim 1, wherein the extrusion foam pump further comprises a gland, and when the extrusion foam pump is in a non-working state, the gland covers the top of the thread cap and is pressed on the air-liquid foam outlet for sealing effect.

5. The extrusion foam pump of claim 1, wherein when the extrusion foam pump works, people applies an external acting force to the extrusion bottle to extrude the extrusion bottle, at this time, the liquid in the extrusion bottle rises along the air-water replacement pipe after being applied with the extrusion acting force, enters the liquid inlet hole and meanwhile proceeds into the first mixing area after pushing away the inner blade of the blade valve, at the same time, the air between the valve fixing seat and the splitter proceeds into the air inlet hole after being applied with the extrusion acting force, and meanwhile proceeds into the first mixing area after pushing away the inner blade of the blade valve, the liquid and the air are preliminarily mixed in the first mixing area to form an air-liquid mixture, the air-liquid mixture continues to rise to enter the second mixing area and form a foam air-liquid mixture when passing through the filter screen, and the foam air-liquid mixture is jet out from the air-liquid foam outlet finally to be used by people.

6. The extrusion foam pump of claim 5, wherein after the external acting force acting on the extrusion bottle is removed, the inner blade is pressed on and covers the liquid inlet hole and the air inlet hole simultaneously by means of an inner suction force generated by the recovery deformation force of the extrusion bottle, so as to seal the liquid inlet hole and the air inlet hole, at the same time, the outer blade is opened from the air return hole, the air at the outside of the valve fixing seat enters the space between the valve fixing seat and the splitter through the air return hole and further enters the extrusion bottle through the splitter air return hole and the air-water replacement pipe, in order to recover the extrusion bottle to the original state, and the cyclic process is repeated in this way.

7. A method for generating foams by an extrusion foam pump, comprising the following steps:
a first step, a gland is taken off from the extrusion foam pump, wherein the extrusion foam pump comprises an extrusion bottle and a foam pump body, the foam pump body is inserted in the extrusion bottle, liquid is filled in the extrusion bottle, the foam pump body comprises a thread cap, a valve fixing seat, a splitter and a blade valve, wherein the thread cap covers the extrusion bottle to connect the foam pump body to the extrusion bottle, an air-liquid foam outlet is formed in the top of the thread cap, the valve fixing seat is inserted in the thread cap, an air-liquid passage is arranged at the center of the valve fixing seat, the air-liquid passage is communicated with the air-liquid foam outlet, a filter screen is arranged at the top of the air-liquid passage and between the thread cap and the valve fixing seat, a second mixing area is formed in the inner cavity of the filter screen, and a first mixing area is formed between the bottom of the filter screen and the valve fixing seat,
a lower end of an air-water replacement pipe is inserted in the extrusion bottle, the top of the air-water replacement pipe is connected with the splitter, the splitter is inserted in the valve fixing seat, the blade valve is clamped between the splitter and the valve fixing seat, the blade valve comprises an inner blade and an outer blade, an air return hole is formed in the surrounding of the valve fixing seat, the outer blade movably covers the air return hole from below, the splitter is provided with a liquid inlet hole, an air inlet hole and a splitter air return hole, the inner blade movably covers the tops of the liquid inlet hole and the air inlet hole, the liquid inlet hole and the air inlet hole are formed in the top of the splitter relative to the valve fixing seat, and the splitter air return hole is formed in the surrounding of the splitter,
a second step, an external acting force is applied to the extrusion bottle to extrude the extrusion bottle, at this time, the liquid in the extrusion bottle rises along the air-water replacement pipe after being applied with the extrusion acting force, enters the liquid inlet hole and meanwhile proceeds into the first mixing area after pushing away the inner blade of the blade valve, at the same time, the air between the valve fixing seat and the splitter proceeds into the air inlet hole after being applied with the extrusion acting force, and meanwhile proceeds into the first mixing area after pushing away the inner blade of the blade valve,
the liquid and the air are preliminarily mixed in the first mixing area to form an air-liquid mixture, the air-liquid mixture continues to rise to enter the second mixing area and form a foam air-liquid mixture when passing through the filter screen, and the foam air-liquid mixture is jet out from the air-liquid foam outlet finally, and
a third step, the external acting force acting on the extrusion bottle is removed, the inner blade is pressed on and covers the liquid inlet hole and the air inlet hole simultaneously by means of an inner suction force generated by the recovery deformation force of the extrusion bottle, so as to seal the liquid inlet hole and the air inlet hole,
at the same time, the outer blade is opened from the air return hole, the air at the outside of the valve fixing seat enters the space between the valve fixing seat and the splitter through the air return hole and further enters the extrusion bottle through the splitter air return hole and the air-water replacement pipe, in order to recover the extrusion bottle to the original state, and the cyclic process is repeated in this way.
